(19) United States
(12) Patent Application Publication
(10) Pub. No.: US 2016/0275091 A1
(43) Pub. Date: Sep. 22, 2016

(54) METHOD AND APPARATUS FOR FACILITATING ARTICLE GENERATION USING MYKOLUMN APPLICATION

(71) Applicants: AHMAD SAQER, Dubai (AE); Mohammed Gheyath, Dubai (AE)

(72) Inventors: AHMAD SAQER, Dubai (AE); Mohammed Gheyath, Dubai (AE)

(21) Appl. No.: 15/071,074

(22) Filed: Mar. 15, 2016

Related U.S. Application Data
(60) Provisional application No. 62/133,983, filed on Mar. 16, 2015.

(51) Int. Cl. G06F 17/30; G06F 3/0481; G06F 17/21; H04L 29/08

(52) U.S. Cl. CPC G06F 17/3089; H04L 67/02; G06F 3/04817; G06F 17/211; G06F 17/30011; G06F 17/3087

(57) ABSTRACT

Mykolumn mobile application, in one embodiment, is a writing column application (“WCA”) configured to facilitate writing articles, reading articles, and providing feedback relating to published articles. To operate Mykolumn for generating cyber content, a network system coupling to multiple portable devices, communications network(s), network elements, and base stations is used. Upon receiving a writicle request from a portable device such as an iPhone® requesting additional writings associated to an article, a database associated with the article is retrieved from a local storage. After storing the writicle request in a writicle entry of the database, a popularity index indicating the popularity of the article is calculated based on the information stored the database. In one aspect, the dimension of icon associated with the article is adjusted in response to the popularity index.

### PRIORITY

This application claims the benefit of priority based upon U.S. Provisional Patent Application Ser. No. 62/133,983, filed on Mar. 16, 2015 in the name of Ahmad Sager, et al., and having a title of “Method and Apparatus for facilitating Article Generation using Mykolumn via Communications Network,” hereby incorporated into the present application by reference.

### FIELD

The exemplary embodiment(s) of the present invention relates to the field of network communication. More specifically, the exemplary embodiment(s) of the present invention relates to content production.

### BACKGROUND

A conventional high-speed communication network, which is able to deliver massive amount of information and/or data between sources and destinations, may contain one or more networks for the information to reach its destination. The communication network, for example, includes wired and wireless communications networks. The networks, for instance, may include, but not limited to, wired network, backbone network, wireless network, cellular network, wireless personal area network (“WPAN”), wireless local area network (“WLAN”), wireless metropolitan area network (“MAN”), or a combination of wired, backbone, wireless, cellular, WPAN, WLAN, MAN, WIFI, or the like.

With increasing popularity of web or cyber media such as motion pictures, real-time posting, blogs, and/or articles, web or electronic publishing becomes an important part of web content generation process. For example, web publishing, also known as electronic publishing, e-publishing, online publishing, digital publishing, cyber publishing, is a process of publishing original content on the Internet or online. Note that the web content publication can be text, videos, digital images, artwork, or other forms of media directing to entertainment, shopping, sports, art, technology, and/or politics.

A problem, however, associated with a conventional online publication is that it involves cumbersome steps as well as time consuming procedures. For example, a process of writing, editing, approving/verifying, publishing, and/or feedback often takes time and effort. As a result, many writings and/or articles never had the opportunities to be published.

### SUMMARY

The following summary illustrates a simplified version(s) of one or more aspects of present invention. The purpose of this summary is to present some concepts in a simplified description as more detailed description that will be presented later.

Mykolumn mobile application, in one embodiment, is a writing column application (“WCA”) configured to facilitate writing articles, reading articles, and providing feedback relating to published articles. To operate Mykolumn for generating cyber content, a network system coupling to multiple portable devices, communications network(s), network elements, and base stations is used. Upon receiving a writicle request which indicates that an article wanted request has been sent from a portable device such as an iPhone® requesting additional writings associated to an article, a database associated with the article is retrieved from a local storage. After storing the writicle request in a writicle entry of the database, a popularity index indicating the popularity of the article is calculated based on the information stored the database. In one aspect, the dimension of icon associated with the article is adjusted in response to the popularity index.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a computing network configured to provide cyber or web publication using Mykolumn in accordance with one embodiment of the present invention;

FIG. 2 is a block diagram illustrating a communication network capable of communicating with various user equipments (“UEs”) using Mykolumn for handling publications in accordance with one embodiment of the present invention;

FIG. 3 a set of screen shots of smartphone illustrating a landing page of Mykolumn facilitating user authentication and article uploading in accordance with one embodiment of the present invention;

FIG. 4 is a set of screen shot of smartphone illustrating pages of Mykolumn exploring and/or researching various articles in accordance with one embodiment of the present invention;

FIG. 5 is a screen shot of Mykolumn illustrating an article page displaying a selected article in accordance with one embodiment of the present invention;

FIG. 6 is a screen shop of Mykolumn illustrating a writer profile page showing writer profile settings in accordance with one embodiment of the present invention;

FIGS. 7A-D are screen shots of a smartphone illustrating various page of Mykolumn in accordance with one embodiment of the present invention;

FIGS. 8 and 9A-B are screen shots of smartphone illustrating a process of publishing an article via Mykolumn in accordance with one embodiment of the present invention;

FIG. 10 is a screen shot of a smartphone illustrating an exploring page of Mykolumn displaying various articles with different icon sizes in accordance with one embodiment of the present invention;

FIG. 11 is a block diagram illustrating a digital processing device such as UE, smartphone, and/or network device capable of implementing Mykolumn in accordance with one embodiment of the present invention; and

FIG. 12 is a flowchart illustrating a process of implementing Mykolumn capable of resizing dimension of an icon based on the popularity index in accordance with one embodiment of the present invention.

### DETAILED DESCRIPTION

Exemplary embodiment(s) of the present invention is described herein in the context of a method, system and apparatus of Mykolumn capable of facilitating writing, editing, publishing, and/or feedbacks via a communications network.

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

References to “one embodiment,” “an embodiment,” “example embodiment,” “various embodiments,” “exemplary embodiment,” “one aspect,” “an aspect,” “exemplary aspect,” “various aspects,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of this disclosure.

Communication network means any type of network that is able to transmit data in a form of packets, cells, or frames. A communication network may be, for example, an IP communication network or an IP network carrying traffic packed in cells such as ATM (Asynchronous Transfer Mode) type, on a transport medium, for example, the TCP/IP or UDP/IP type. ATM cells are the result of decomposition (or segmentation) of packets of data, IP type, and those packets (here IP packets) comprise an IP header, a header specific to the transport medium (for example UDP or TCP) and payload data. The IP network may include one or more a satellite network, a DVB-RCS (Digital Video Broadcasting-Return Channel System) network, an SDMB (Satellite Digital Multimedia Broadcast) network, a terrestrial network, a cable (xDSL) network or a mobile or cellular network (GPRS/EDGE, or UMTS (where applicable of the MBMS (Multimedia Broadcast/Multicast Services) type, the evolution of the UMTS known as LTE (Long Term Evolution), or DVB-H (Digital Video Broadcasting-Handhelds)), a hybrid (satellite and terrestrial) network, and/or an optical network.

The term “system” is used generically herein to describe any number of components, elements, sub-systems, devices, packet switch elements, packet switches, routers, networks, computer and/or communication devices or mechanisms, or combinations of components thereof. The term “computer” is used generically herein to describe any number of computers, including, but not limited to personal computers, embedded processors and systems, control logic, ASICs, chips, workstations, mainframes, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to the block and flow diagrams, are typically performed in a different serial or parallel ordering and/or by different components and/or over different connections in various embodiments in keeping within the scope and spirit of the invention.

One embodiment of the present invention discloses Mykolumn which is a mobile application or writing column application (“WCA”) configured to facilitate writing, reading, and commenting. Mykolumn, in one aspect, is able to generate web or cyber content. To implement Mykolumn, a network system coupling to multiple portable devices, communications network(s), network elements, and base stations is used. Upon receiving a writicle request which indicates that an article wanted request has been sent from a portable device such as an iPhone® requesting additional writings associated to an article, a database associated with the article is retrieved from a local storage. After storing the writicle request in a writicle entry of the database, a popularity index indicating the popularity of the article is calculated based on the information stored the database. In one aspect, the dimension of icon associated with the article is adjusted in response to the popularity index.

Mykolumn, in one aspect, is a mobile application capable of publishing writings, blogs, and/or articles. After obtaining a feedback associated with a publication such as an article or blog, the stored information associated with the publication is retrieved. Based on the nature of feedback and stored information, one or more actions may be activated. For example, the original author of the publication may be notified if a wanted request is received.

In one example, Mykolumn includes various features, such as, but not limited to, wanted flag, interactive icon, Offline access, rich editing tools, and the like. While wanted flag indicates readers' responses such as demanding similar articles as well as comments, interactive icon or icon of article such as a picture or photo is activated. The size of picture or icon displayed on the website can be dynamically adjusted based on number of followers and/or readers. For example, larger the picture or icon indicates more readers and/or followers. Offline feature provides automatic download relevant articles from a selected website to a portable device, such as an iPhone, iPad, tablet, and/or smartphone. Rich editing tool, in one example, provides user-friendly editing tools available to potential writers to assist a user to write blogs or articles via a portable device or a smartphone.

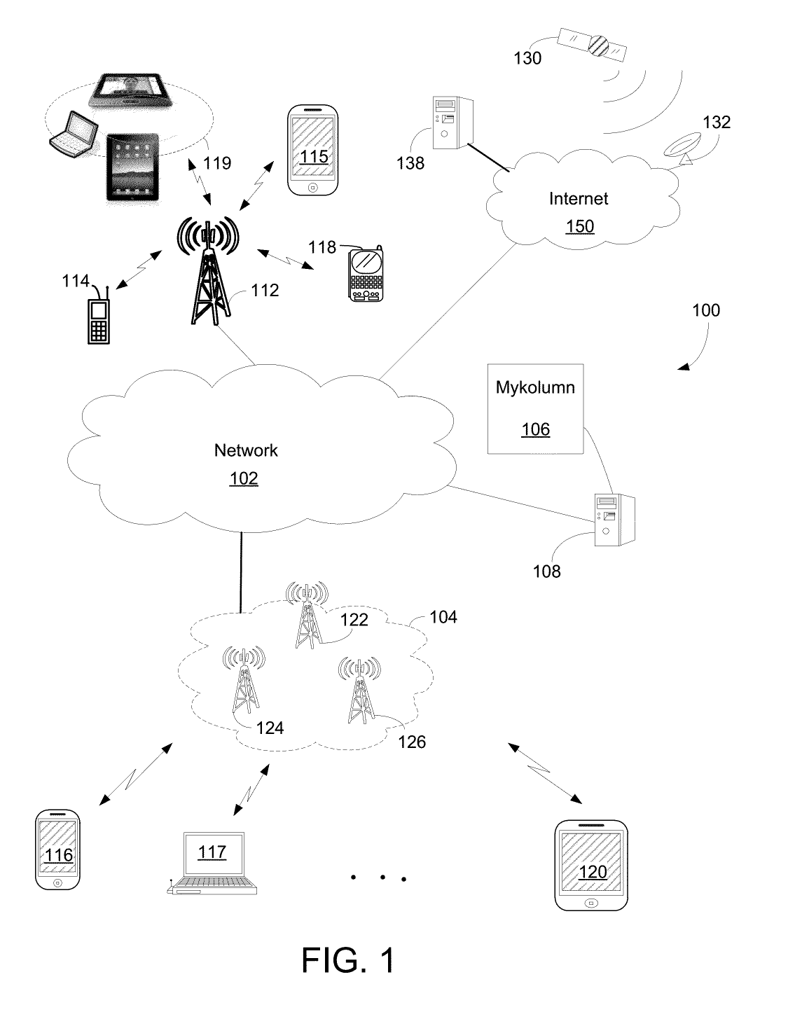

FIG. 1 is a block diagram 100 illustrating a computing network configured to provide cyber or web publication using Mykolumn in accordance with one embodiment of the present invention. Diagram 100 illustrates Mykolumn 106, communication network 102, switching network 104, Internet 150, and portable electric devices 114-120. Network 102 can be wide area network (“WAN”), metropolitan area network (“MAN”), local area network (“LAN”), satellite/terrestrial network, or a combination of WAN, MAN, and LAN. It should be noted that the underlying concept of the exemplary embodiment(s) of the present invention would not change if one or more blocks (or networks) were added to or removed from diagram 100.

Network 102 includes multiple network nodes, not shown in FIG. 1, wherein each node may include mobility management entity (“MME”), radio network controller (“RNC”), serving gateway (“S-GW”), packet data network gateway (“P-GW”), or HomeAgent to provide various network functions. Network 102 is coupled to Internet 150, Mykolumn server 108, base station 112, and switching network 104. Server 108, in one embodiment, is a dedicated network machine capable of providing Mykolumn and/or Mykolumn management. Mykolumn can be software, hardware, or combination of software and hardware component. A function of Mykolumn is to provide WCA to any web connected devices that wish to install and operate Mykolumn for reading, writing, commenting, following, publishing, and the like.

Switching network 104, which can be referred to as packet core network, includes cell sites 122-126 capable of providing radio access communication, such as 3G (3^{rd} generation), 4G, or 5G cellular networks. Switching network 104, in one example, includes IP and/or Multiprotocol Label Switching (“MPLS”) based network capable of operating at a layer of Open Systems Interconnection Basic Reference Model (“OSI model”) for information transfer between clients and network servers. In one embodiment, switching network 104 is logically coupling multiple PEDs 114-120 across a geographic area via cellular networks. It should be noted that the geographic area may refer to a campus, city, metropolitan area, country, continent, or the like.

Base station 112, also known as cell site, node B, or eNodeB, includes a radio tower capable of coupling to various user equipments (“UEs”), PEDs, or electrical user equipments (“EUEs”). The term UEs, PEDs, and EUEs are referring to the similar portable devices and they can be used interchangeably. For example, UEs or PEDs can be cellular phone 114, handheld device 118, iPhone®116, tablets and/or iPad® 120 via wireless communications. Handheld device 118 can be a smartphone, such as iPhone®, BlackBerry®, Android®, and so on. Base station 112, in one example, facilitates network communication between mobile devices such as portable handheld device 114-120 via wired and wireless communications networks. It should be noted that base station 112 may include additional radio towers as well as other land switching circuitry.

Internet 150 is a computing network using Transmission Control Protocol/Internet Protocol (“TCP/IP”) to provide linkage between geographically separated devices for communication. Internet 150, in one example, couples to supplier server 138 and satellite network 130 via satellite receiver 132. Satellite network 130, in one example, can provide many functions as wireless communication as well as global positioning system (“GPS”). For example, Mykolumn 106 can communicate with various smartphones 114-120 via satellite network 130, Internet 150, network 102, and/or switching network 104.

Mykolumn 106, which can be software, firmware, hardware, or a combination of software, hardware, and firmware, facilitates online publication with various features, such as wanted requests, interactive icons, offline reading, and/or user-friendly editing tools. While the wanted requests or wanted flags are used to urge author(s) to write more, the interactive icon is used to indicate the popularity of an article. Offline reading allows a user to download selected articles to the user's portable device. The user-friendly editing tool provides rich writing software allowing a user to generate articles or blogs more efficiently.

An advantage of employing Mykolumn is to provide WCA for facilitating publication as well as reading the publications. For example, Mykolumn enables a writer to write and publish more quickly. Also, Mykolumn enables a reader to read a published article as well as demand similar articles based on published articles.

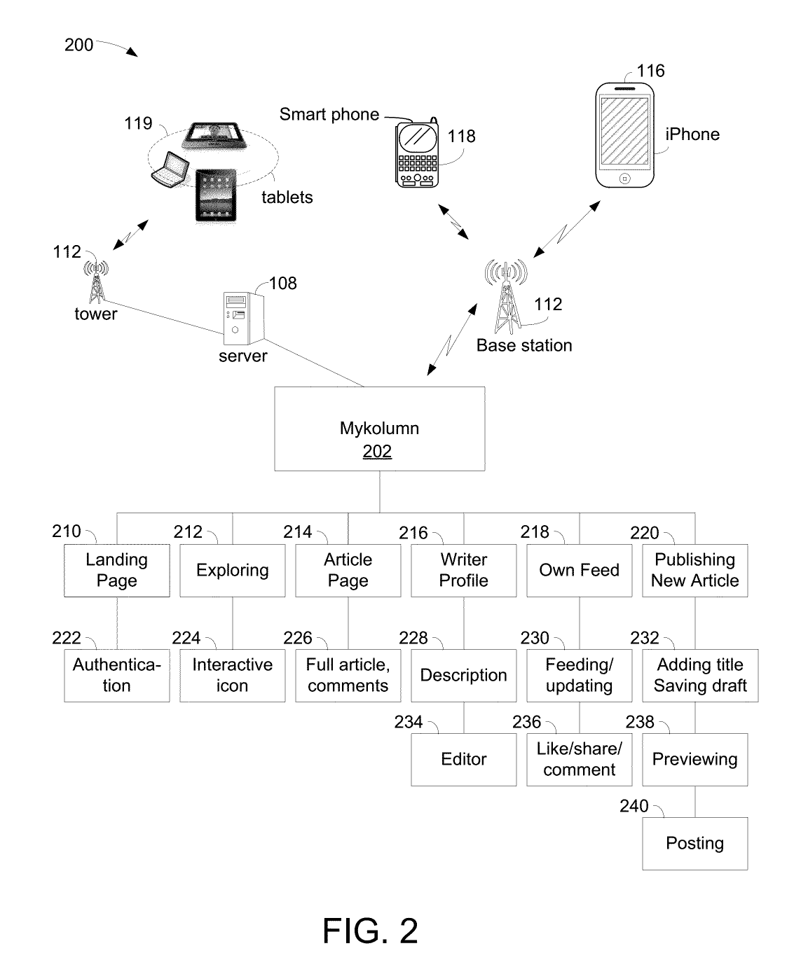

FIG. 2 is a block diagram 200 illustrating a communication network capable of communicating with various UEs using Mykolumn to handle publications in accordance with one embodiment of the present invention. Diagram 200 includes Mykolumn 202, portable devices 116-119, and server 108 connected by towers or base stations 112. Mykolumn 202, in one embodiment, includes various modules, such as landing page 210, exploring 212, article page 214, writer profile 216, own feed 218, and publishing 220. It should be noted that the underlying concept of the exemplary embodiment(s) of the present invention would not change if one or more modules (or networks) were added to or removed from diagram 200.

Landing page module 210, which includes an authentication component 222, is capable of authenticating a user based on internal stored verification data. Landing page or landing page module 210 can be often referred to as a lead capture page or a lander. A purpose of landing page is that it is an enter page to Mykolumn loaded in response to an activation of WCA by a user. For example, a landing page can be a web page that a visitor could arrive at or land on. In one aspect, Mykolumn 202 employs landing page 210 to authenticate a user or users.

Exploring or exploring module 212, in one embodiment, includes a feature of presenting articles to users with a predefined presentation format. For example, exploring 212 may selectively present articles to a user based on prior selections or predefined options. The users, for instance, can be authors, readers, regulators, administrators, and/or subscribers. Exploring 212, in one aspect, includes a component of interactive icon 224. Interactive icon 224 is able to dynamically adjust the physical size of an icon based on the popularity of the article. The popularity of article, for example, is based a set of parameters, such as number of follows or number of times that the article has been accessed, commented, and/or read.

Article page module or article page 214 includes a full article page component 226 which is capable of displaying full article when the article is selected or clicked by a user. If the user is a registered user, the user can download the selected articles to a portable device such as a smartphone for offline reading and/or access. Depending on the applications, article page 214 can also accept comments generated by a registered user.

Write profile or write profile module 216 includes a description component 228 and an editorial component or editor 234. Description component 228 is used to explain or describe a user or author related to prior publications. For example, description component 228 may include information relating to the number of published articles, unpublished articles, comments section, like sections, and wanted flags or requests. Editor 234, in one embodiment, provides writer's editorial software or author's editorial tools, such as, but not limited to, Microsoft Word®, WordPerfect®, WriteItNow®, WriteWay®, or any other user-friendly word processors. In one aspect, a user or author can optionally select which word processor(s) or editorial tool he or she would like to use. Write Profile 216, for example, remembers user's preferences. Note that a writer editorial component provides at least one user-friendly editorial tool for writing and publishing.

Own feed or own feed component 218 is able to facilitate interactive comments. For example, a reader can express whether he or she likes your blog or not. Also, a reader may comment, criticize, and/or praise your article(s) or post(s) by like/share/comment component 236. If the author is a popular writer, own feed can be dynamically updated in real-time by feeding/updating component 230.

A publishing component or publisher 220 is configured to assist publishing new articles, blogs, and/or posts. Publisher 220, in one embodiment, includes an adding-title component 232, previewing component 238, and posting component 240. To publish or post an article, the author is generally required to be registered as a writer. An advantage of using publisher 220 is that it allows a user to quickly generate and post an article online.

Mykolumn, in one aspect, includes multiple categories of users. For example, the first category of user is un-registered user who has a right to read the articles or publications. The second category of user is registered users who can write and read without approval and/or authentications. The third category of user is writers who can read, write, and approve (or sign-off) the articles for publication.

In operation, various algorithms and/or processes are used to perform Mykolumn including the functions of wanted request, interactive icons, rich editing tools, and/or offline features. In one aspect, a process of “wanted” feature includes the following steps,
1. User A wants or desires user B to write more articles relating one or more published user B's articles,
   A. User A clicks a button called “wanted” button and sends a wanted request to user B;
   B. User B subsequently receives a push notification or email indicating one or more people wanting user B to write more;
   C. User B profile shows at least two numbers next to the “wanted” icon wherein one number indicates an accumulative requests while the other number indicates the current request(s).
2. User B prepares and writes a new article,
   A. When user B publishes the new article, the current number of wanted icon is reset to zero (0);
   B. All users who have pushed “wanted” buttons for user B will receive notifications indicating the new publication by the user B;
   C. Mykolumn is able to provide ranking index for top wanted or demanded writers based on users demand or wanted requests received.
      A process of “weighted icon size” or interactive icon, in one embodiment, includes the following steps,
A. Retrieve a list of all article wherein the size of icon may change based on a mathematical algorithm using various parameters as shown below:
   1. Number of readers
   2. Number of comments
   3. Number of “wanted” requests
   4. Number of followers
   5. Timing associated with above steps from 1 to 4
B. The icon size of the article in the landing page will depend on the computed value wherein the larger number causes bigger icon.
C. The icon size adjustment may be dynamically updated which will be managed between a minimum scale size and a maximum scale size.
   A process of providing “rich editing” feature, in one embodiment, includes the following steps,
A. User A can easily use the writing tools in his/her smartphone as part of the application;
B. A populated circle will appear and to have all common features to enhance the writing appearance such as format, text size, color, look, adding media (links, images, videos, audio, etc.) to be demonstrated as easy to use icons and/or buttons. In one aspect, the populated circle further includes audio recording author/writer voice message with automatic transcribes tailored to author's way of speaking.
   A process of “offline” reading feature, in one embodiment, includes the following steps,
A. A user can go to any writers profile and have an option to save all current and future articles to a specific writer.
B. A user can go inside any specific article to any writer and select any individual article to be read later when offline. Offline means the smartphone is not connected the Internet.
C. The application has a local data base that enables a user to read saved or selected article when the user is offline (i.e. not connected to the net).
   For operating “offline” writing feature, the process, in one aspect, includes the following steps,
A. User has an option after the user logs into the application and save the draft.
B. User can also access the application when user's portable device is offline, and be able to save the application when not connected on the net as a draft.
C. User is able to publish the saved article when user's UE is back online.

To identify or calculate popularity index associated with a post or article, the following tables illustrate exemplary algorithms that can be used to implement Mykolumn. It should be noted that the values in the table are for the illustrations. Different values (or percentages) should be used for different applications.

TABLE 1

| | Poster Points Factors: |
|---|---|
| 1 | Favorite: Points = count * 0.40 |
| 2 | Repost: Points = count * 0.25 |
| 3 | Share: Points = count * 0.20 |
| 4 | Like: Points = count * 0.13 |
| 5 | View: points = count * 0.02 |

TABLE 2

| | User Points Factors: |
|---|---|
| 1 | Writicles: points = count * 0.3 |
| 2 | Followers: points = count * 0.3 |
| 3 | Posts points: points = count * 0.4 |
| 4 | Reports: points = −count * 0.3 (negative value) |

Mykolumn, in one aspect, provides a web platform providing unique user interface capability that allows users to easily read, write, comment, follow, demand, and publish articles. In one example, the platform is free to interested reader, writer, follower, and/or commentator. In addition, readers are able to access all topics or categories posted on the website or platform. In one example, registered users can start to write and link to other social media platforms, such as, but not limited to, Instagram®, Twitter®, or Snapchat®.

An advantage of using Mykolumn is that it is a dedicated writing platform for writers and readers with voting capability. Mykolumn provides applications with visual illustrations such as pictures and videos. Another advantage is that it allows people to write more and post more articles or blogs. Mykolumn offers a user-friendly environment allowing general public to write and post what they see and feel about events, stories, politics, and/or world affairs. In addition, writing and/or reading can develop different aptitude especially for new generations and/or youngsters who live across the globe. Mykolumn, in one aspect, provides support for new generation to interactively write, read, and/or comment. To facilitate writing and reading, Mykolumn offers mobile applications on portable devices such as iPhones® and Android®, as well as website or cloud access.

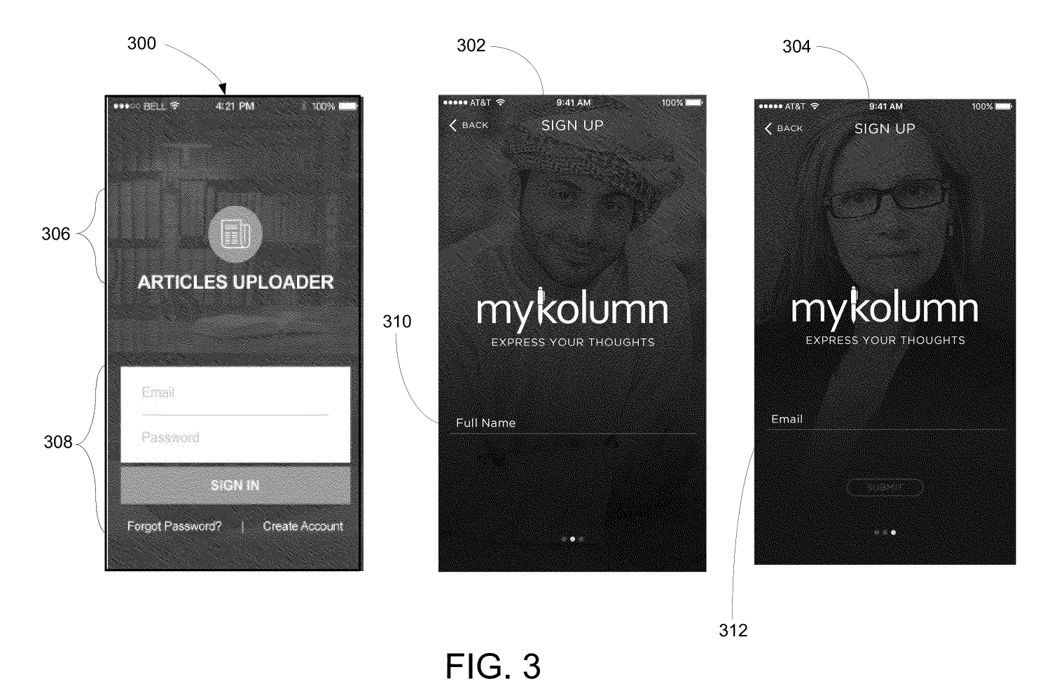

FIG. 3 is a set of screen shots of smartphone 300-304 illustrating landing pages of Mykolumn capable of facilitating user authentication and article uploading in accordance with one embodiment of the present invention. Screen shot 300 of a smartphone shown a screen of iPhone® includes a head section 306 and a login section 308 wherein head section 306 indicates the landing page with a title of Articles Uploader. It should be noted that the underlying concept of the exemplary embodiment(s) of the present invention would not change if one or more blocks (or sections) were added to or removed from diagram 300.

Login section 308, in one aspect, includes an authentication module capable of handling existing users as well as new users. For example, login section 308 provides a new account button allowing a new user to establish a new account. Login section 308 is also able to link to or login to other social media websites, such as Facebook®, Twitter®, and/or Google+®. Alternatively, the landing page can also provide an option for un-registered users to read, write, search, and/or explore desirable articles, blogs, and/or posts.

Screen shot 302 illustrates a land page of a smartphone capable of accessing Mykolumn using user's full name as indicated by numeral 310. Alternatively, screen shot 304 illustrates a land page of a smartphone capable of facilitating a user to access Mykolumn via user's email as indicated by numeral 312. It should be noted that other options for accessing Mykolumn are possible. For example, a user may access or login Mykolumn using fingerprints recognition, voice recognition, facial recognition, geographic location identifier, and the like.

A benefit of using Mykolumn having a landing page is that it simplifies read, write, and publishing articles/blogs for newer or younger generations who use their smartphone as their primary electronic devices.

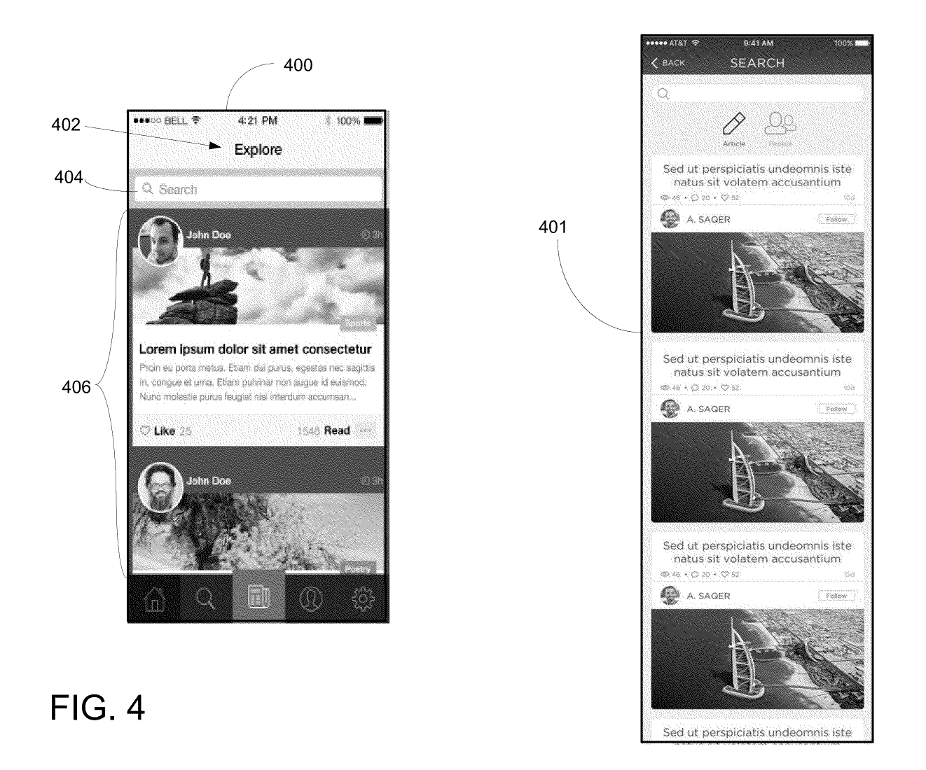

FIG. 4 is a set of screen shots 400-401 of smartphone illustrating an exploring page of Mykolumn capable of exploring and/or researching various articles in accordance with one embodiment of the present invention. Screen shot 400 showing an exploring page includes a head section 402, search area 404, and article displaying area 406. In one aspect, article displaying area 406 by default presents most popular and/or up-to-date articles. Photos and icons showing writers and nature of articles are also displayed to draw or attract readers' interest. In one aspect, popularity indicators such as time stamp of publication, like counts, and/or read counts. To read an article, one click on article will expand the box or display area to read a selected article or blog with scrolling options for viewing the entire article. In one embodiment, a second click on the selected article can shrink or minimize the article. Alternatively, click on side or swipe to right allows a reader to access the full article.

Screen shot 401 illustrates a list of articles associated with a poster, writer, or author upon a search. Depending on the applications and/or preferences, articles with photos are displayed. To see additional articles, scroll down the display area is need to view the rest of articles.

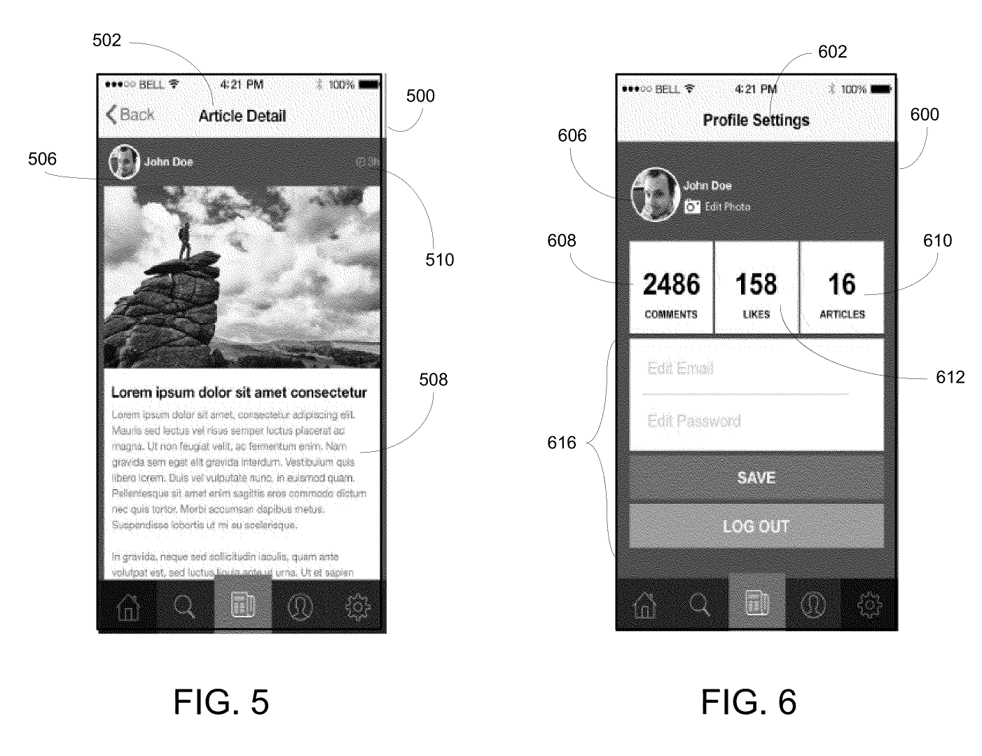

FIG. 5 is a screen shot of Mykolumn illustrating an article page 500 displaying a selected article in accordance with one embodiment of the present invention. Article page 500 includes a head section 502, author photo 506, display area 508, and publication time stamp 510 indicating the time of publishing. Mykolumn provides article page 500 on a smartphone such as iPhone® when a reader clicks or touches an article requesting to see the full or entire article. While head section 502 indicates that current screen shot is an article page with detail content, author photo 506 describes author's facial structure or appearance with author's name. Display area 508 displays at least a portion of the article in which Mykolumn allows a reader to swipe left of display area 508 to load previous page while swiping right on display area 508 to load the next page. In one aspect, a reader is able to enter comments on any articles if the reader or user is registered with Mykolumn. In one example, Mykolumn allows a read to click author photo 506 to see author profile.

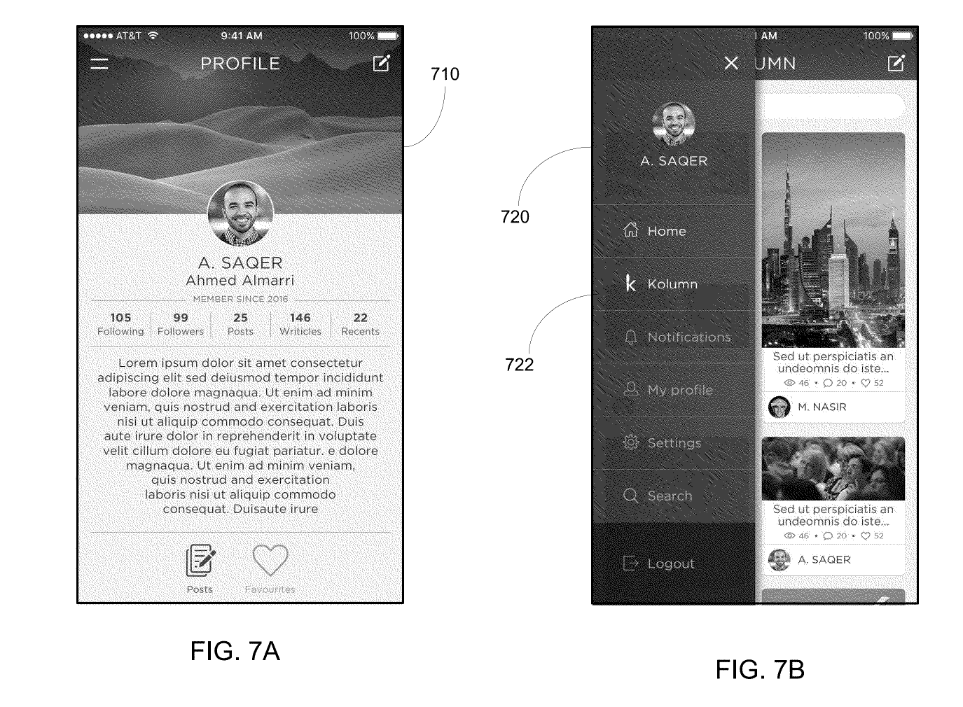

FIG. 6 is a screen shop of Mykolumn illustrating a writer profile page 600 showing writer profile settings in accordance with one embodiment of the present invention. Writer profile page 600 includes a head section 602, author photo 606, comment count 608, like-section 612, article section 610, and writer authenticator 616. Mykolumn uses writer profile page 600 to communicate with authors or writers. When an author wants to access his or her own profile setting, the author is able to see number of comments to his/her articles at comments count 608. If comments count 608 is clicked, writer profile page 600 is able to display a list of comments such as 2486 comments relating to author's publications. For instance, author's publication includes 16 articles as indicated by article section 610.

Like-section 612 shows number of like or approvals have been received. When like-section 612 is clicked, a list of like messages such as 158 like messages is displayed. Note that like messages should also indicate the like message associated with which article or blog. Write authenticator 616 includes a login area allowing an author or writer to login his or her account if the author is a registered user. Alternatively, write authenticator 616 can create a new account for a new author or writer. It should be noted that write profile page 600 may include other flags such as wanted requests and follower requests.

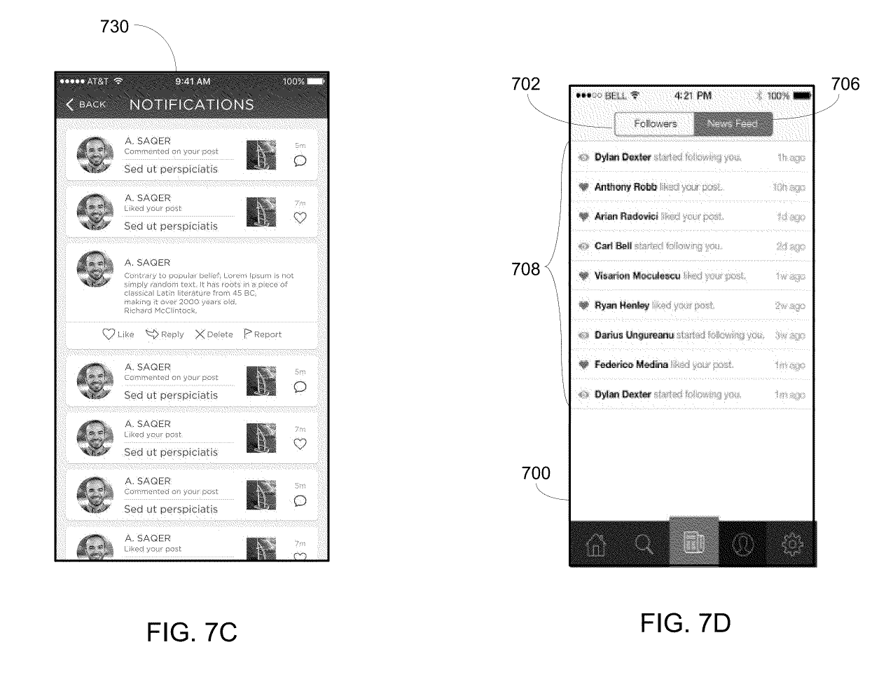

FIGS. 7A-D are a set of screen shots of a smartphone illustrating various exemplary screen pages associated with Mykolumn operation in accordance with one embodiment of the present invention. Profile page 710 illustrates an introduction of an author with various indicators. The indicators include number of following, number of followers, number of posts, number of writicles, and number of recent(s). Screen shot 720 illustrates a user's pull-down page to manage and/or navigate Mykolumn. For instance, the user, which has a photo 720, can move the cursor to Mykolumn indicator to show articles and/or posts. Screen shot 730 illustrates a notification page showing a list of notices including comments, like flags, reports, and the like.

Feeding page 700 includes a follower section 702, news feed 706, and feed display 708. In one aspect, feed display 708 lists followers and readers who like your article(s). In operation, upon registration with Mykolumn, the user is able to receive updated feed immediately. The feed, in one example, includes, but not limited to, readers like-indicators, comments, and/or sharing of article. In one embodiment, feed information is updated in real-time showing the popularity of the article(s) instantaneously.

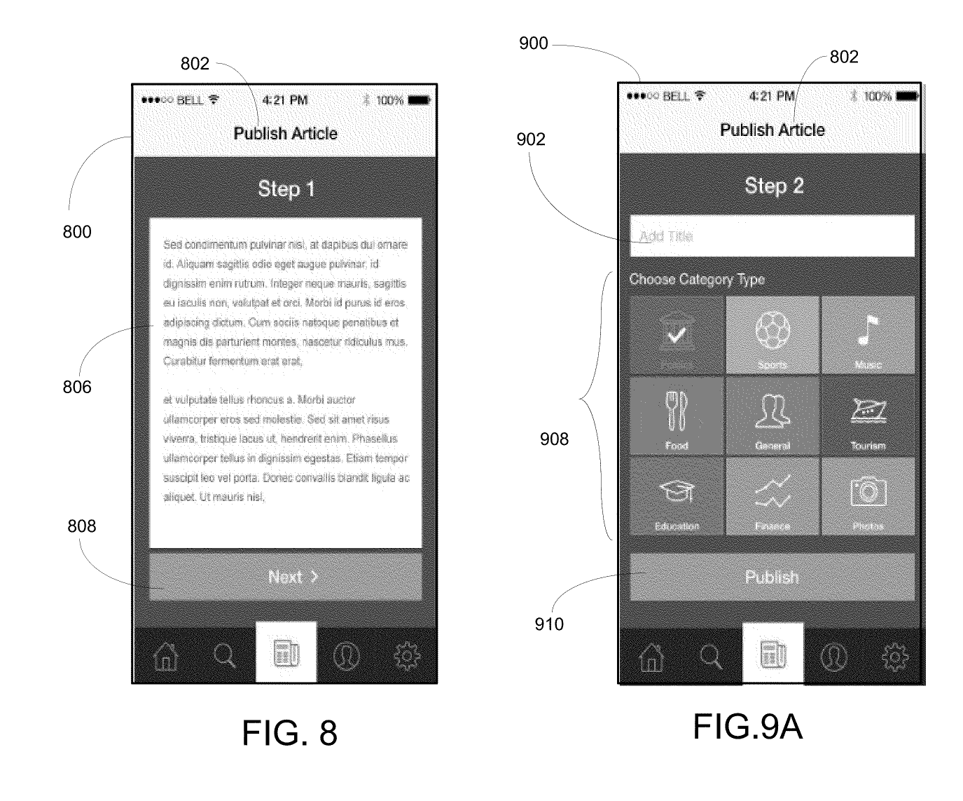

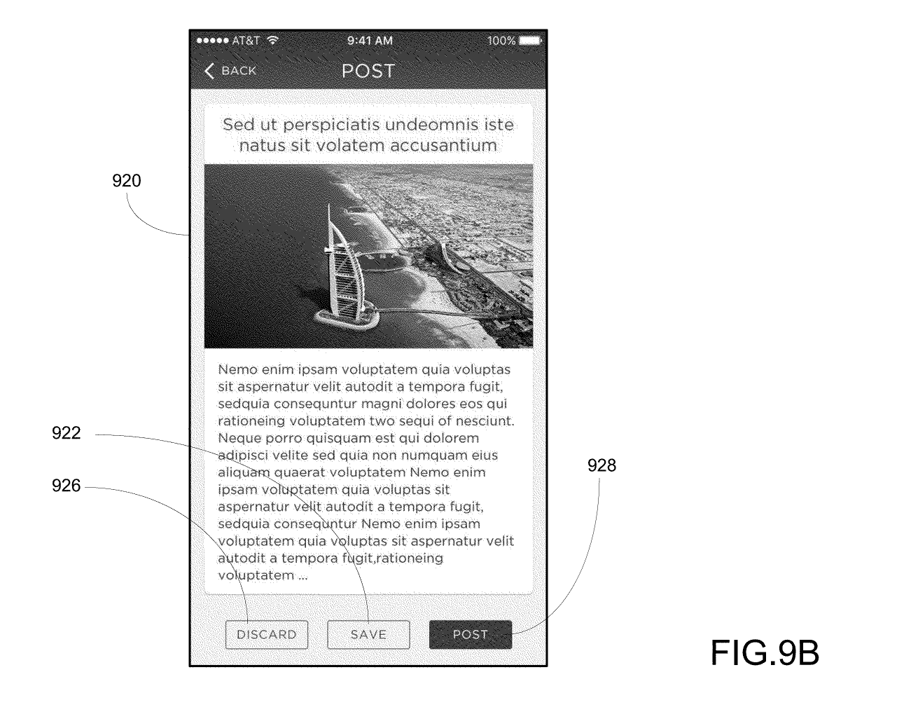

FIGS. 8-9AB are screen shots 800, 900, and 920 of smartphone illustrating a process of publishing an article via Mykolumn in accordance with one embodiment of the present invention. Screen shot 800 includes a head section 802, displaying area 806, and next step button 808. Screen shot 800 basically shows step 1 for publishing an article or blog. In this step, author can draft or write an article, blog, or post. It should be noted that author can save the writings at any time, and can continue to write the saved article at a later time. When the article is ready to be published, the next step button 808 is clicked.

Screen shot 900 includes a head section 802, title area 902, category 908, and publish button 910. Screen shot 900, in one aspect, is step 2 of publishing an article or blog. In this step, author can select a category for the article, blog, or post via category 908, and add a title at title area 902. When a category of category 908 is selected, the selected category, in one embodiment, runs an automated pre-publication review for the article to be published.

For example, when a politics category is selected at category 908, the politics category automatically runs a pre-publication review to examine and verify whether the draft complies with the minimal publication rules. The minimal publication rules, for example, include steps of preventing articles or blogs from publishing if certain rule or rules are violated. For example, the rules prevent drafts or articles to us offensive words, explicit photos/pictures, solicitation of criminal acts, advertisements, and the like. The rules may also include grammatical checks, spelling check, and/or language syntax check. In another embodiment, the selected category can also convert the current draft into another language. For example, if the draft is in English, the selected category can translate the draft from English to French. When publishing, the article or blog can be published in multiple language simultaneously. When the article fails to pass the pre-publication review, the author or writer will be notified and is offered an opportunity to fix the errors. When the article is ready to be published, publish button 910 is clicked, and the article is published.

Screen shot 920 illustrates a post page display showing an option of discard button 926, save button 922, and post button 928. Discard button 926 allows a user to delete or trash the writing. Save button 922 allows a user to temporary save the writing at Mykolumn and the user can resume writing at a later time. Post button 928 allows a user to post or publish the writing online.

In operation, a process of facilitating content publication via network connected UE such as a smartphone receives an authentication request sent by an UE to Mykolumn across a communications network requesting WCA access. After retrieving the database associated with the authentication request from a local storage based on the UE, the process organizes a writer's profile containing information relating to published articles, writicle indicator, saved drafts, and author preferred editorial tool when the authentication request is authenticated as a registered writer. The writer's profile is subsequently forwarded to the UE permitting the UE to access the WCA.

Alternatively, after organizing a follower's profile containing information relating to accessed articles, wanted request, and saved drafts, the authentication request is authenticated as a registered reader. The process tracks the user writing progress and periodically backing up the draft for preventing unintentional loss. When the article passes a verification process of publication provided by the WCA, the user with assistance of Mykolumn publishes the article. In one embodiment, the process is further capable of generating a report summarizing the popularity of published articles, categorizing social trends, and reading preferences across a demographic information.

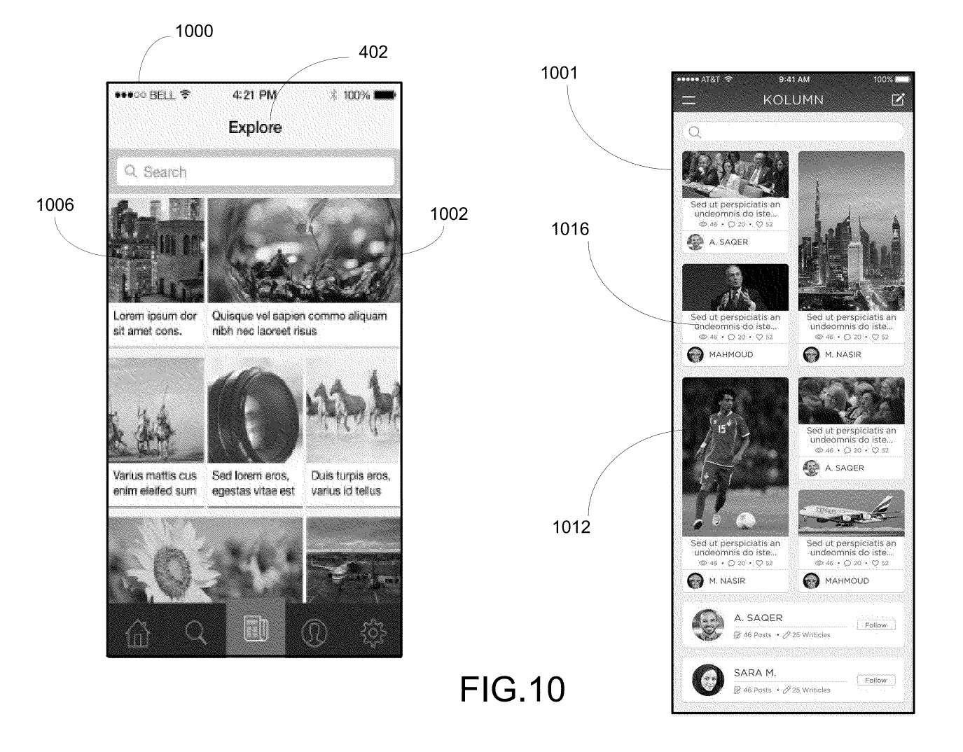

FIG. 10 is a set of screen shots of a smartphone illustrating displaying pages 1000-1001 of Mykolumn displaying various articles with different icon sizes in accordance with one embodiment of the present invention. Exploring page 1000 includes various articles with icons 1002-1006 wherein some of the icons have larger icon sizes than others. Note that different size of photos or icons indicate popularities associated with the articles. For example, the article with icon 1002 appears more popular than the article with icon 1006 because the physical size of icon 1002 is larger than physical size of icon 1006. A reader following a group of writers is able to view latest article published by writers in the group. Once the reader expands the selected articles, the reader can comment or send wanted flag.

Displaying page 1001, which is similar to page 1000, shows larger pages with inflated photos or icons as indicated by numeral 1012 to emphasize the popularity of the articles. Similarly, for the articles having average popularity, the articles with regular size of icons such as indicated by numeral 1016 are presented.

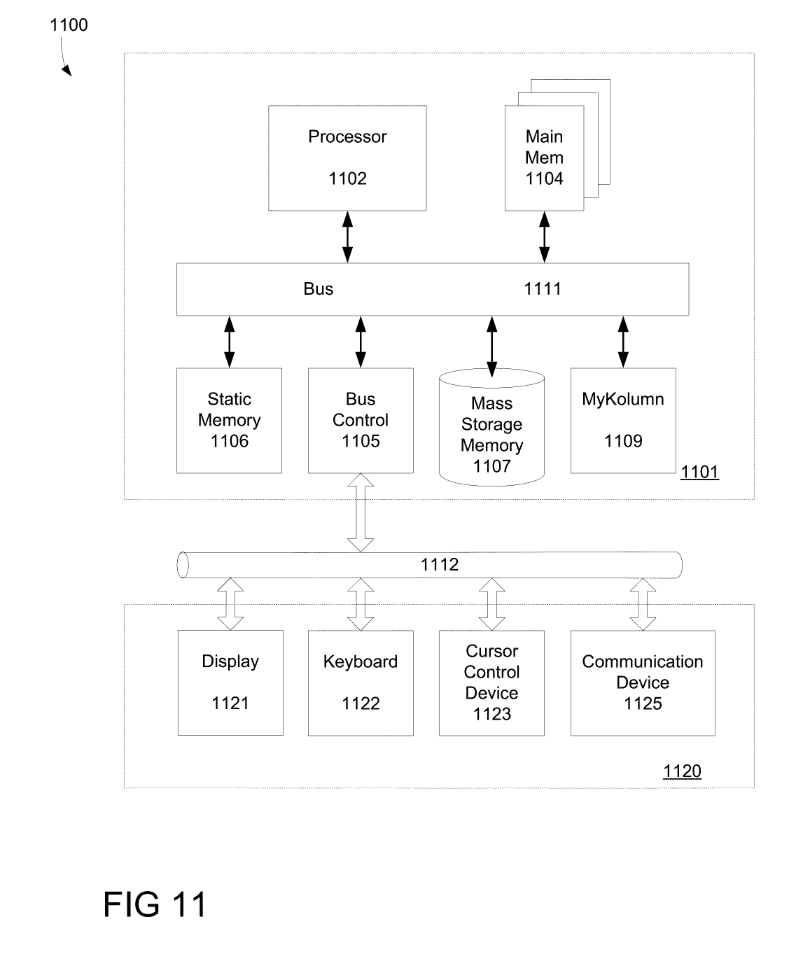

FIG. 11 is a block diagram 1100 illustrating a digital processing device such as UE, smartphone, and/or network device capable of implementing Mykolumn in accordance with one embodiment of the present invention. Computer system or Mykolumn system 1100 can include a processing unit 1101, an interface bus 1111, and an input/output (“IO”) unit 1120. Processing unit 1101 includes a processor 1102, a main memory 1104, a system bus 1111, a static memory device 1106, a bus control unit 1105, a mass storage memory 1107, and a Mykolumn unit 1109. It should be noted that the underlying concept of the exemplary embodiment(s) of the present invention would not change if one or more blocks (circuit or elements) were added to or removed from diagram 1100.

Mykolumn unit 1109, in one embodiment, is able to provide and manage Mykolumn or WCA in system 1100. For example, Mykolumn unit 1109 provides various writing and reading features, such as wanted flags, interactive icons, offline reading, rich editing tools, publications, and the like.

Bus 1111 is used to transmit information between various components and processor 1102 for data processing. Processor 1102 may be any of a wide variety of general-purpose processors, embedded processors, or microprocessors such as ARM® embedded processors, Intel® Core™2 Duo, Core™2 Quad, Xeon®, Pentium™ microprocessor, Motorola™ 68040, AMD® family processors, or Power PC™ microprocessor.

Main memory 1104, which may include multiple levels of cache memories, stores frequently used data and instructions. Main memory 1104 may be RAM (random access memory), MRAM (magnetic RAM), or flash memory. Static memory 1106 may be a ROM (read-only memory), which is coupled to bus 1111, for storing static information and/or instructions. Bus control unit 1105 is coupled to buses 1111-1112 and controls which component, such as main memory 1104 or processor 1102, can use the bus. Bus control unit 1105 manages the communications between bus 1111 and bus 1112. Mass storage memory 1107, which may be a magnetic disk, an optical disk, hard disk drive, floppy disk, CD-ROM, and/or flash memories are used for storing large amounts of data.

I/O unit 1120, in one embodiment, includes a display 1121, keyboard 1122, cursor control device 1123, and communication device 1125. Display device 1121 may be a liquid crystal device, cathode ray tube (“CRT”), touch-screen display, or other suitable display device. Display 1121 projects or displays images of a graphical planning board. Keyboard 1122 may be a conventional alphanumeric input device for communicating information between computer system 1100 and computer operator(s). Another type of user input device is cursor control device 1123, such as a conventional mouse, touch mouse, trackball, or other type of cursor for communicating information between system 1100 and user(s).

Communication device 1125 is coupled to bus 1111 for accessing information from remote computers or servers, such as server 104 or other computers, through wide-area network 1102. Communication device 1125 may include a modem or a network interface device, or other similar devices that facilitate communication between computer 1100 and the network. Computer system 1100 may be coupled to a number of servers 104 via a network infrastructure.

The exemplary aspect of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary aspect of the present invention. Alternatively, the steps of the exemplary embodiment of the present invention may be performed by specific hardware components that contain hard-wired logic for performing the steps, or by any combination of programmed computer components and custom hardware components.

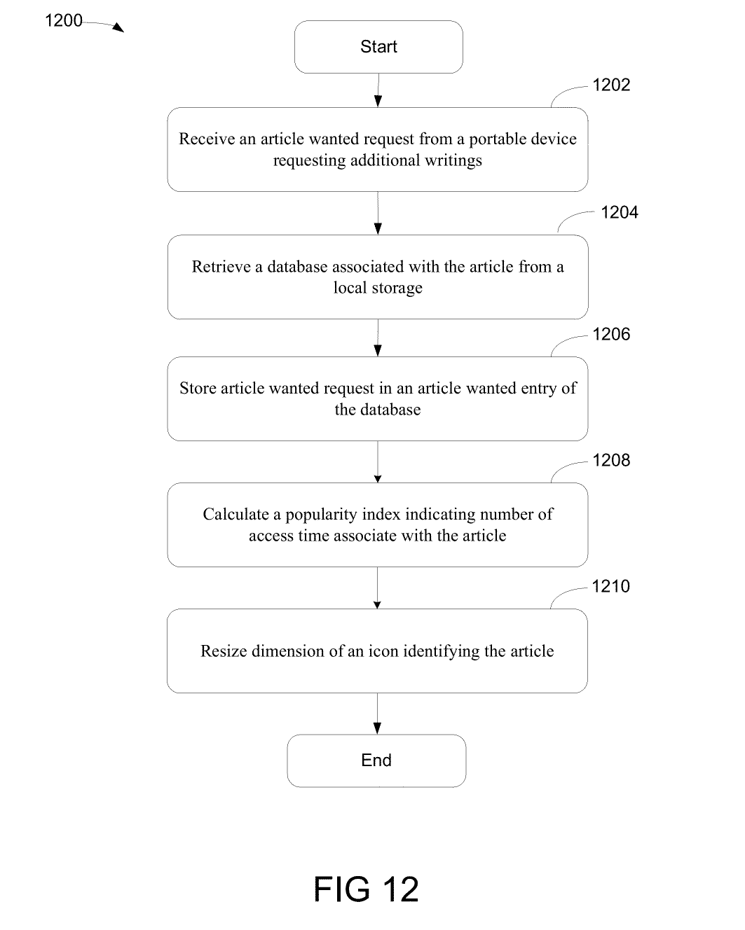

FIG. 12 is a flowchart 1200 illustrating a process of implementing Mykolumn capable of resizing dimension of an icon based on the popularity index in accordance with one embodiment of the present invention. At block 1202, the process receives a writicle request which indicates that an article wanted request has been sent from a portable device requesting additional writings associated to the article. In one example, the process obtains a wanted signal or flag sent from an end user via an iPhone® using Application (“App”) of Mykolumn demanding new articles associated to the currently published article. Upon identifying a stored profile associated with the author of the article, a writicle notification is forwarded to the author based on the stored profile.

At block 1204, a database associated with the article is retrieved from a local storage based on the writicle request. Upon identifying an author profile, the process retrieves a profile table containing a comment section, a like section, a wanted section, and an article section relating to the author.

At block 1206, the writicle request is stored in a writicle entry of the database. In one example, a counter associated with in a demand entry of the database is incremented indicating receipt of a new wanted request.

At block 1208, a popularity index indicating popularity of the article which includes number of read times associate with the article is calculated based on information stored the database. After identifying number of times that the article has been read or downloaded or accessed, the popularity of article or blog is determined or assessed.

At block 1210, the dimension of icon or icon picture identifying the article is resized in response to the popularity index. Mykolumn, in one example, is resided in a server or Mykolumn server which is connected to a communications network via a transceiver. Mykolumn server establishes a cyber-read and/or cyber-write environment allowing various readers to read and write interactively. Mykolumn also provides an authentication process used to authenticate participants and/or authors as well as managing the publishing process. The process is able to distribute and manage App across the network for facilitating and tracking publications and demands. In one aspect, the physical size of icon may be increased based on a higher value of the popularity index. For example, after receiving a second writicle request from a second portable device requesting additional writings associated to a second article, a second database associated with the second article is retrieved from the local storage. Upon storing the second writicle request in a writicle entry of the second database, a second popularity index indicating popularity of the second article is calculated based on information stored the second database. The dimension of second icon is resized or adjusted in response to the second popularity index.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method capable of generating web content via network connected portable devices, comprising:
receiving a first writicle request from a first portable device requesting additional writings associated to a first article;
retrieving a first database associated with the first article from a local storage based on the first writicle request;
storing the first writicle request in a writicle entry of the first database;
calculating a first popularity index indicating popularity of the first article based on information relating to followers and number of times the first article that has been read; and
resizing dimension of a first icon picture identifying the first article in response to the first popularity index.

2. The method of claim 1, further comprising:
connecting to a communications network via a transceiver of a Mykolumn server to provide a cyber-read and cyber-write environment enabling readers to interactively participate reading, writing, and demanding additional articles; and
facilitating an authentication process to authenticate participants and authors manage article publishing process.

3. The method of claim 2, further comprising distributing and managing Mykolumn Application (“App”) via the communications network for facilitating and tracking article publications and articles in demand.

4. The method of claim 1, wherein receiving a first writicle request includes receiving a wanted signal from an end user via an iPhone® by a Mykolumn Application (“App”) demanding new articles associated to a currently published article.

5. The method of claim 4, wherein receiving a first writicle request further includes:
identifying a stored profile associated with an author of the first article; and
forwarding a writicle notification to the author based on the stored profile.

6. The method of claim 1, wherein retrieving a first database associated with the first article includes:
identifying an author profile associated with the first article; and
retrieving a profile table containing a comment section, a like section, a wanted section, and an article section associated with the author.

7. The method of claim 1, wherein storing the first writicle request includes incrementing a counter associated with in a demand entry of the first database.

8. The method of claim 1, wherein calculating a first popularity index includes,
identifying number of times that the first article have been read within a predefined period of time; and
determining number of first writicle requests received.

9. The method of claim 1, wherein resizing dimension of a first icon picture includes increasing physical size of the first icon picture based on a higher value of the first popularity index.

10. The method of claim 1, further comprising:
receiving a second writicle request from a second portable device requesting additional writings associated to a second article;
retrieving a second database associated with the second article from the local storage based on the second writicle request;
storing the second writicle request in a writicle entry of the second database;
calculating a second popularity index indicating popularity of the second article based on information stored the second database; and
resizing dimension of a second icon picture identifying the second article in response to the second popularity index.

11. A digital processing system having a mobile application for assisting writing and reading, comprising:
a landing page module able to display a login page to authenticate user(s);
an exploring module coupled to the land page module and configured to provide interactive icon display based on popularity of articles associated with icons;
an article page module coupled to the explore module and able to display full article and able to download related articles for offline access; and
a writing profile module coupled to the article page module and able to provide description and edition.

12. The system of claim 11, further comprising an own feed component coupled to the write profile module and able to facilitate interactive comments.

13. The system of claim 12, further comprising a publisher component coupled to the write profile module and able to publish new articles based on writers authorizations.

14. The system of claim 11, wherein the write profile module further includes a writer editorial component capable of providing at least one user-friendly writer editorial tool for typing and publishing.

15. The system of claim 11, wherein the write profile module further includes a writer editorial component capable of providing at least one user-friendly writer editorial tool for typing and publishing.

16. A method of facilitating content publication via network connected user equipment (“UE”), comprising:
receiving a first authentication request sent by a first UE to a writing column application (“WCA”) across a communications network requesting a WCA access;
retrieving a first database associated with the first authentication request from a local storage based on the first UE;
organizing a first writer's profile containing information relating to published articles, writicle indicator, saved drafts, and author preferred editorial tool when the first authentication request is authenticated as a registered writer; and
forwarding the first writer's profile with a first authorization to the first UE permitting first user of the first UE to access the WCA.

17. The method of claim 16, further comprising organizing a first follower's profile containing information relating to accessed articles, wanted request, and saved drafts when the first authentication request is authenticated as a registered reader.

18. The method of claim 16, further comprising tracking the first user writing progress and periodically backing up draft to prevent unintentional loss.

19. The method of claim 17, further comprising assisting the first user to publish an article when the article has passed a verification process of publication provided by the WCA.

20. The method of claim 16, further comprising generating a report summarizing popularity of recorded articles and categorizing social trends and reading preferences across a predefined demographic data.
